(19) United States
(12) Patent Application Publication
(10) Pub. No.: US 2011/0165289 A1
(43) Pub. Date: Jul. 7, 2011

(54) FEED PREMIX CONTAINING MULTIPLE TRACE ELEMENTS AND PREPARING METHOD THEREOF

(75) Inventors: Xuefeng Yu, Hubei (CN); Zhihong Li, Hubei (CN); Minghua Yu, Hubei (CN); Juan Yao, Hubei (CN); Bin Tan, Hubei (CN)

(73) Assignee: ANGELYEAST CO., LTD, Yichang, Hubei (CN)

(21) Appl. No.: 13/054,894

(22) PCT Filed: Sep. 23, 2009
(86) PCT No.: PCT/CN09/74136

§ 371 Date: Mar. 21, 2011

(30) Foreign Application Priority Data
Dec. 2, 2008 (CN) 200810180771.8

(51) Int. Cl. A23K 1/175; A23K 1/00

(52) U.S. Cl. 426/60; 426/74

(57) ABSTRACT

A feed premix containing multiple trace elements and preparing method thereof, the feed premix contains trace elements of copper, iron, manganese and zinc, and yeast autolysate, the proportion of the four trace elements of which depending one the feeding standards of various animals. The method includes reacting the salts of copper, iron, manganese and zinc with a yeast autolysate.

### FIELD

The invention relates to a feed addictive, more particularly, to a premix containing trace elements and yeast autolysate.

### BACKGROUND

Multiple trace elements are essential for animal growth, therefore it is required to add appropriate amount of multiple trace elements to feed. Currently, there are mainly two methods for adding the trace elements, one of which is inorganic premix of trace elements, i.e. mixing inorganic salts according to certain formula based on actual animal needs, then adding the premix to feed for fulfilling animals' physiological needs, e.g. the method described in The Preparing of Copper-yeast Powder Feed Addictive for Pig, by Li Sanqiang, et al, Acta Agriculturae Boreali-occidentalis Sinica, 1993, 2(4): p 85-88. The second is organic products containing single trace element, e.g. amino acid chelate zinc glycinate, ferrous methionine, and the like. Using such a method, by single addition or combination of inorganic trace element into the premix, a product with higher quality than premix containing all the inorganic trace elements is obtained.

One of the disadvantages in the first method above-mentioned is that, the animal absorptivity of the trace elements in inorganic form tends to be low, since most of the trace elements of this kind finally are made into the environments by defecation, resulting in both drain of trace elements and harm to the environments. There are also disadvantages in the second method above-mentioned. In view of increasing absorptivity, organic products containing trace elements are developed with higher absorptivity and thus mitigating environmental harm. However, the higher cost of producing these organic products containing single trace element with high purity restrains badly the application.

### SUMMARY

The following simplified summary is provided in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

An object of this invention is to provide a feed premix containing multiple trace elements and with higher absorptivity of animal.

The premix provided by this invention is formed by a certain reaction of several trace elements and a yeast autolysate, wherein the reaction is realized by the reacting of the salts of the said trace elements with the said yeast autolysate under the condition of pH 3.0-6.0 and temperature of 40-100° C. The products are being formulated in terms of the four sorts of elements based on the national feeding standards for different animals in different physiological periods, thus the needs of animals for multiple trace elements are being met, with higher absorptivity and mitigated harm to the environments. In the mean time, these products are not the traditional ones containing pure organic trace element, thus the cost thereof is significantly reduced.

To the accomplishment of the foregoing and related ends, certain illustrative aspects are described herein in connection with the following description. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the examples.

### DETAILED DESCRIPTION

In one aspect of the invention, a feed premix containing a yeast autolysate and multiple trace elements is provided. The said trace elements include copper, iron, manganese and zinc. The invention characterizes in that these elements are not contained by simple mixture in the premix of the invention, in fact, the four elements are formulated based on the national feeding standards for different animals in different physiological periods. Then through the reaction of the trace elements and the yeast autolysate, highly absorbable compound trace elements are being produced, so as to facilitate animal absorption.

Raw materials used in the invention include yeast autolysis solution and trace elements, such as copper, iron, manganese, and zinc. The said yeast autolysis solution includes autolysis solution derived from active yeast and inactive yeast, and the yeast includes but is not limited to Saccharomyces cerevisiae, baker's yeast and Candida, the crude protein in dry matter of the said yeast autolysis solution used varies from 30% to 65%.

Trace elements in the said premix are generally introduced in the form of salts, such as sulfates, carbonates, hydrochlorides, phosphates, hydrogen phosphates (monohydrogen phosphates or dihydrogen phosphates), and basic carbonates. In the invention, sulfates and hydrochlorides are preferably used.

Although the mechanism of reaction of yeast autolysate and the said inorganic trace elements is yet unknown, and no reliable analytic methods have been developed to measure the combination of the trace elements and the yeast autolysate, it is found through experiments that, compared with simple inorganic mixture, the premix containing multiple trace elements provided by the invention has an evident advantage, i.e. an increased bioavailability.

When preparing yeast autolysate premix, a predefined amount of the said salts of trace elements may be directly added to the yeast autolysis solution through autolysis treatment, and the PH and concentration of the mixture may be adjusted by water and acid/alkali, and the reaction maintains a period of time under appropriate temperature. The salt of trace element may also be added in the form of solution. In an alternative embodiment, the preparation method includes the following steps: (1) providing a needed amount of salt solution of trace elements with adjusted pH and concentration; (2) providing solution of yeast autolysate, and adjust pH and concentration to an appropriate value; (3) mixing the solution obtained in (1) and (2), and reacting under an appropriate temperature, to make the said trace elements and the organic compounds in the said autolysate combine.

Autolysis method of yeast is known in the art. The reaction for preparing the premix in the invent is conducted under the temperature between 40° C. to 100° C., preferably between 60° C. to 90° C., and generally with pH 3.0-6.0, preferably 4.0-5.5, e.g. 4.0, 4.3, 4.6, 4.9, 5.0, 5.2, 5.4, and 5.5, more preferably 4.5-5.2. The concentration of the autolysis solution is preferably 10%-15%. In a preferred embodiment, the reaction contains two steps: (1) under the first reaction temperature of 40-70° C., preferably 50-68° C., more preferably 55-65° C., most preferably 60-65° C., the reaction lasts for 10-600 minutes, preferably 120-600 minutes, more preferably 240-540 minutes, most preferably 360-480 minutes, (2) under the second reaction temperature of 70-100° C., preferably 75-95° C., more preferably 80-92° C., most preferably 85-92° C., the reaction lasts for 10-600 minutes, preferably 10-480 minutes, more preferably 60-240 minutes, most preferably 60-120 minutes.

The proportions of the trace elements used in the invention, i.e. copper, iron, manganese, and zinc, are adjusted upon nutritional needs of different animals. For example, in the premix special for broiler chickens of 0-4 weeks, the proportions of copper, iron, manganese and zinc are respectively 8 mg/kg, 80 mg/kg, 60 mg/kg, and 40 mg/kg; and in the premix special for growing pigs of 10-20 kg, the proportions of the said four elements are 5 mg/kg, 80 mg/kg, 3 mg/kg, and 80 mg/kg. In other types of premix containing yeast autolysate and compound trace elements, the proportions of copper, iron, manganese and zinc are determined based on the national feeding standards for various animals.

### EXAMPLES

The detailed method is elaborated by the following example of production of premix counting for 1% in the special feed for broiler chicken of 0-4 weeks. In this example, the inorganic salt used is sulfate, and the strain of the yeast autolysis solution used is active beer yeast (with crude protein of 45%). The target amount of the product is 1,000 kg.

The proportions of copper, iron, manganese and zinc in the feed formula are 8 mg/kg, 80 mg/kg, 60 mg/kg, and 40 mg/kg respectively. Since the premix counts for 1% by weight when mixing with the feed, the proportions of copper, iron, manganese and zinc in the feed formula are then 800 mg/kg, 8000 mg/kg, 6000 mg/kg, and 4000 mg/kg respectively. Therefore, the proportions of raw materials, i.e. copper sulfate, ferrous sulfate, manganese sulfate and zinc sulfate, are 1969 mg/kg, 21,714 mg/kg, 16,472 mg/kg, 9,908 mg/kg respectively, and 0.20%, 2.17%, 1.65%, and 0.99% respectively if converted in percentage. Then the raw materials of the yeast autolysate dry matter used counts for 1-0.20%-2.17%-1.65%-0.99%=94.99%. The yeast autolysate dry matter needed for producing 1,000 kg products is 1000×94.99%=949.9 kg. The needed amounts of copper sulfate (heptahydrate), ferrous sulfate (heptahydrate), manganese sulfate (heptahydrate) and zinc sulfate (pentahydrite) are respectively 1000×0.20%×(18×7+160)/160=3.58 kg, 1000×2.17%×(18×7+152)/152=39.69 kg, 1000×1.65%×(18×7+151)/151=30.27 kg, and 1000×0.99%×(18×5+161)/161=15.43 kg.

9.5 m³ of yeast autolysis solution containing 10% of dry matter (approximately 949.9 kg of dry matter contained) is measured and put in the reactor, 3.58 kg of copper sulfate (heptahydrate), 39.69 kg of ferrous sulfate (heptahydrate), 30.27 kg of manganese sulfate (heptahydrate) and 15.43 kg of zinc sulfate (pentahydrite) are added, with full agitation. The pH is adjusted to 4.0 by using sulfuric acid. The temperature is then increased to 55° C. and the reaction is initiated and lasts for 4 hours with agitation. Then the temperature is increased to 90° C. and the reaction lasts for another 1 hour. After spray drying, the powder products needed are obtained.

Effect Test

1.1 Design of Test

It is designed to be a single factor test with 2 treatment groups and 5 repetitions. The two treatment groups are control group and experimental group. The control group uses basal diet, in which the proportions of copper, iron, manganese and zinc are respectively 8 mg/kg, 80 mg/kg, 60 mg/kg and 40 mg/kg. The four trace elements are in form of inorganic sulfate. The experimental group uses the yeast autolysate premix special for broiler chicken of 0-4 weeks produced in the above example 1, for substitution of the trace elements, i.e. copper, iron, manganese and zinc, in the basal diet. The proportions of copper, iron, manganese and zinc in the overall feed for experimental group are 8 mg/kg, 80 mg/kg, 60 mg/kg and 40 mg/kg.

1.2 Testing Animal

100 healthy Avian 0 day-age broiler chickens are divided into two groups on a random basis. Five repetitions are set for each group, and each repetition applies to 10 chickens.

1.3 Testing Feed and Management

1.3.1 Testing Feed: The composition of testing feed and its nutritional level are shown in the table 1 below.

TABLE 1
Composition of Basal diet and Nutritional Level

| | Proportion by | | |
|---|---|---|---|
| Raw Materials | Weight (%) | Nutritional Level | |
| Maize | 65.00 | Metabolizable | 2.930 |
| | | Energy Mcal/kg | |
| Soybean Meal | 26.23 | Crude Protein % | 20.94 |
| Fish Meal | 5.99 | Calcium % | 1.00 |
| Methionine | 0.16 | Available | 0.45 |
| | | Phosphorus % | |
| Salt | 0.25 | Lysine % | 1.20 |
| Stone Powder | 1.14 | Methionine % | 0.52 |
| CaHPO₄ | 1.22 | | |

1.3.2 Feeding Management

The test lasts for 3 weeks. Prior to the test, the chicken houses, coops, water tanks and feed tanks are being sterilized and immunized by following the immunization procedure.

1.4 Sampling Time

Broiler chickens of 21 day-age, on the 22nd day morning, without feeding, are being weighted, blood-collected and then sampled.

1.5 Test Indicators

1.5.1 Content of Trace Elements in the Kidney

1.5.2 Relative Bioavailability of Trace Elements

1.5.3 Daily Weight Gain

1.5.4 Feed-Gain Ratio

Results and Analysis (Table 2)

TABLE 2
Test Results

| | Control Group | Experimental Group |
|---|---|---|
| Copper in the Kidney | 36.76 | 38.20 |
| (mg/kg) | | |
| Relative Bioavailability of | 100 | 103.9 |
| Copper (%, Kidney) | | |
| Iron in the Kidney (mg/kg) | 275.68 | 312.44 |
| Relative Bioavailability of | 100 | 113.3 |
| Iron (%, Kidney) | | |
| Manganese in the Kidney | 6.86 | 9.9 |
| (mg/kg) | | |
| Relative Bioavailability of | 100 | 144.3 |
| Manganese (%, Kidney) | | |
| Zinc in the Kidney (mg/kg) | 112.38 | 132.33 |
| Relative Bioavailability of | 100 | 117.8 |
| Zinc (%, Kidney) | | |
| Daily Weight Gain (g/d) | 25.93 | 28.07 |
| Feed-Gain Ratio | 1.85 | 1.74 |

Based on the results described above, the conclusion goes that, by using the product of the invention, the bioavailability of the trace elements, i.e. copper, iron, manganese, and zinc, for the broiler chickens could be effectively improved, and the daily weight gain of experimental group is increased while the feed-gain ration is decreased.

According to the invention, by the reaction of multiple trace elements of particular proportions and yeast autolysate, a yeast autolysate compound premix product containing multiple trace elements of particular proportions is obtained. The product with high absorptivity of trace elements could provide multiple trace elements, at the same time it is easy to produce with quite low costs. By adjusting the proportions of the trace elements, various yeast autolysate premixes with compound trace elements are obtained to meet various actual needs from different animals.

For example, many sorts of the products, such as yeast autolysate premix with compound trace elements special for piglets, growing pigs, fattening pigs, sows, meat poultry and egg-fowls, could be produced by the method of the invention.

In general, the product by the method according to the invention is featured of combining compound trace elements with compound amino acid and small peptide, and it provides better digestibility over traditional trace elements. In the mean time, the product provides a premix with particular proportions of trace elements, and complete feed could be produced by direct incorporation in proportions.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A feed premix containing multiple trace elements, characterized in that said premix contains trace elements of copper, iron, manganese and zinc, and yeast autolysate; and
an animal absorbable composite is obtained by a reaction of said trace elements and the yeast autolysate;
wherein said reaction is realized by a reaction of salt of said trace elements with said yeast autolysate under the condition of pH 3.0-6.0 and temperature of 40-100° C.

2. The feed premix according to claim 1, wherein proportions of said trace elements of copper, iron, manganese and zinc are determined based on feeding standards for different animals in different physiological periods.

3. The feed premix according to claim 2, wherein said reaction contains two steps: reacting for 10-600 minutes under the temperature of 40-70° C.; and reacting for 10-600 minutes under the temperature of 70-100° C.

4. The feed premix according to claim 1, wherein said trace elements are provided by sulfates, carbonates, hydrochlorides, phosphates, hydrogen phosphates (monohydrogen phosphates or dihydrogen phosphates), and basic carbonates.

5. A method for preparing a feed premix containing multiple trace elements, comprising the step of making salts containing trace elements of copper, iron, manganese and zinc react with yeast autolysate, so as to convert said trace elements into the form of organic compounds.

6. The method according to claim 5, comprising the steps of:
providing salt solution of said trace elements,
providing solution of said yeast autolysate, and
mixing the solution obtained from steps (1) and (2), and reacting under pH 3.0-6.0 and the temperature of 40-100° C.

7. The method according to claim 6, wherein said reaction contains two steps: reacting for 10-600 minutes under the temperature of 40-70° C.; and reacting for 10-600 minutes under the temperature of 70-100° C.

8. The method according to claim 7, wherein said salts of the trace elements are selected from sulfates, carbonates, hydrochlorides, phosphates, hydrogen phosphates (monohydrogen phosphates or dihydrogen phosphates), basic carbonates, acetates or stearate.
